(19) United States
(12) Patent Application Publication
(10) Pub. No.: US 2012/0050202 A1
(43) Pub. Date: Mar. 1, 2012

(54) SURFACE CAPACITIVE TOUCH PANEL WITH MULTI-POINT TOUCH STRUCTURE AND MULTI-POINT TOUCH METHOD THEREOF

(76) Inventors: Wu-Tung KAO, Taichung City (TW); Chih-Ping Shu, Taichung City (TW); Chi-Feng Chiu, Taichung City (TW)

(21) Appl. No.: 12/870,267

(22) Filed: Aug. 27, 2010

(51) Int. Cl. G06F 3/045

(52) U.S. Cl. 345/174

(57) ABSTRACT

The invention relates to a surface capacitive touch panel capable of simultaneously determining different touch points, and a method thereof. The touch panel includes a transparent substrate, a transparent electroconductive layer and an electrode pattern layer. The electrode pattern layer includes at least one first X-side electrode, at least one second X-side electrode, at least one first Y-side electrode and at least one second Y-side electrode, which surround a rectangular area and are formed on a surface periphery of the transparent electroconductive layer. The impedances of the X-side and Y-side electrodes are configured in an ascending manner or a descending manner with a common difference or a common ratio toward the same side, so that impedances of two touch points on the same horizontal or vertical line of the touch panel have a gradient phenomenon to prevent currents from offsetting each other when the two touch points are moved.

### BACKGROUND OF THE INVENTION

1. Field of the Invention

The invention relates to the technological field of a touch panel.

2. Related Art

In the developing history of the electronic apparatus, the birth of the input interface including the keyboard, mouse and touch panel has solved many input control problems. The touch panel can replace most keyboard and mouse functions, and provide the user with the more instinctive and convenient operation experience. However, the multi-point touch smart mobile phone has been available for a period of time, no product with the similar concept can be seen in the market. It is proved that a relatively high threshold does exist in the implementation of this technology. At present, there are many touch techniques in the market, and only the capacitive technique can implement the multi-point touch function. Furthermore, the capacitive touch panels may be classified into a surface capacitive touch panel and a projective capacitive touch panel.

Regarding the surface capacitive technology, as shown in FIG. 1, the touch panel 10 includes a transparent substrate 11, a transparent electroconductive layer 12, an electrode pattern layer 13 and a hard layer 14 for insulation protection. The transparent substrate 11 may be a glass substrate or a plastic substrate. The electrode pattern layer 13 includes two opposite X-side electrodes 131 and two opposite Y-side electrodes 132, which surround a rectangular area and are formed on a periphery portion of the transparent electroconductive layer 12 to compensate for the distribution curve of an electric field on the transparent electroconductive layer 12. In addition, as shown in FIG. 2, four corners of the touch panel 10 are respectively connected to external wires 151, 152, 153, 154 to receive AC sensing signals AC1, AC2, AC3, AC4 for the measurement of the position of one touch point P on the touch panel 10. In practice, the AC sensing signals AC1, AC2, AC3, AC4 are AC square waves or sinusoidal voltage signals with the same amplitude. At this time, currents I1, I2, I3, I4 flow through the wires 151, 152, 153, 154 connected to the outside device, respectively. The current variations ΔI1, ΔI2, ΔI3, ΔI4 of the wires 151, 152, 153, 154 are obtained from the differences between the currents of the wires 151, 152, 153, 154 before and when the touch point P occurs, and the X and Y coordinates of the touch point P may be calculated.

The maximum restriction thereof is that it cannot implement the multi-point touch function. If it works and more than two touch points occur to perform the gesture operation, such as scaling, rotating, dragging or the like, between two touch points, the output currents may offset each other because the positions of the two fingers correspond to each other, so that the mis-judgement of the touch point or operation occurs. Thus, the existing surface capacitive touch panel does not pertain to the ideal technique of the multi-point touch function.

Thus, the projective capacitive technology becomes a hope for the implementation of the multi-point touch function. FIG. 3 is a pictorially exploded view showing a conventional projective capacitive touch panel 20. The capacitive touch panel 20 includes a transparent substrate 21, an X transparent electrode pattern layer 22, a transparent dielectric layer 23 and a Y transparent electrode pattern layer 24, which are stacked together from bottom to top. The X and Y transparent electrode pattern layers 22, 24 are respectively formed with columns and rows of sensing patterns (sensing elements) 25 working in conjunction with other elements to determine one or more touch points on the touch panel 20, wherein the sensing patterns 25 of the X and Y transparent electrode pattern layers 22, 24 are connected to many external wires 28.

Compared with the surface capacitive touch panel, the projective capacitive touch panel adopts a single-layer or a multi-layer, which is patterned to form the matrix with the columns and rows of interlaced sensing patterns 25. Consequently, in the overall life cycle, the precise touch position can be obtained without calibration, and the thicker covering layer can be adopted to perform the multi-point touch operation.

The high manufacturing technology has to be adopted, so its manufacturing cost is extremely high, and the requirement of the actual usage cannot be satisfied. More particularly, due to the affect of its operation, its insufficient storage resource and the sensing precision, the current projective capacitive touch panel only can be adopted to the mass production of the small-size panels. For the industry using the middle and large scales of panels, such as those of notebook computers, industry computers, POS systems, ATMs, medical equipment, monitors, playstations, game industry, and the like, the requirement of the multi-point touch function still cannot be effectively satisfied.

### SUMMARY OF THE INVENTION

It is therefore an object of the invention to provide a multi-point touch method of a surface capacitive touch panel, so that the impedances of two touch points on the same horizontal or vertical line of the touch panel have a gradient phenomenon to prevent currents from offsetting each other when the two touch points are moved. Thus, the coordinates of the different touch points on the touch panel can be effectively determined to satisfy the requirement of the multi-point touch function of the surface capacitive touch panel.

Another object of the invention is to provide a surface capacitive touch panel with a multi-point touch structure to simplify the structure of the multi-point touch panel and to reduce the manufacturing difficulty and cost.

The invention achieves the above-identified objects by providing a surface capacitive touch panel with a multi-point touch structure. The touch panel includes a transparent substrate, a transparent electroconductive layer and an electrode pattern layer stacked together. The electrode pattern layer includes opposite at least one first X-side electrode and at least one second X-side electrode on top and bottom edges of the touch panel, and opposite at least one first Y-side electrode and at least one second Y-side electrode on left and right edges of the touch panel, and the first and second X-side electrodes and the first and second Y-side electrodes surround a rectangular area and are disposed on a surface periphery of the touch panel. The impedances of the first and second X-side electrodes ascend or descend with a common difference or a common ratio toward the same side. The impedances of the first and second Y-side electrodes ascend or descend with a common difference or a common ratio toward the same side. End portions of the first and second X-side electrodes and the first and second Y-side electrodes are respectively electrically connected to wires for measuring output currents.

According to the touch panel of the invention, the impedances of two touch points on the same horizontal or vertical line of the touch panel have a gradient phenomenon to prevent currents from offsetting each other when the two touch points are moved in the scaling, rotating or dragging operation. Thus, the coordinates of the different touch points on the touch panel can be effectively determined to satisfy the requirement of the multi-point touch function of the surface capacitive touch panel. In addition, the structure of the multi-point touch panel can be simplified, and the manufacturing difficulty and cost can be reduced.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a schematically and pictorially decomposed illustration showing the rough architecture of a conventional surface capacitive touch panel.

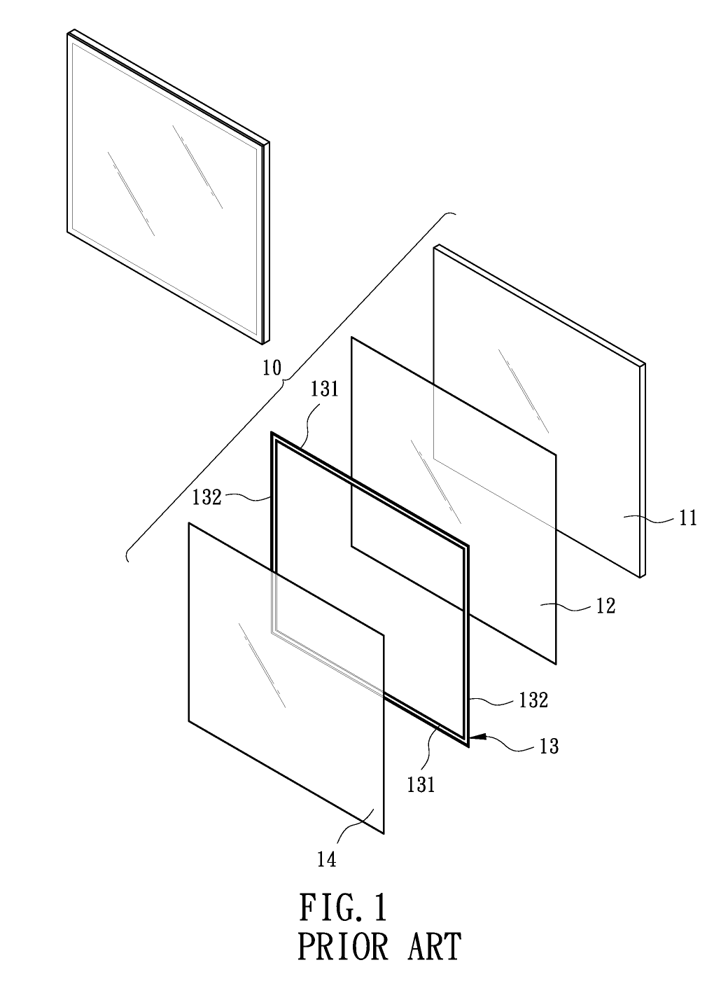

FIG. 2 is a schematic illustration showing that the conventional surface capacitive touch panel receives a sensing signal to determine a touch point position.

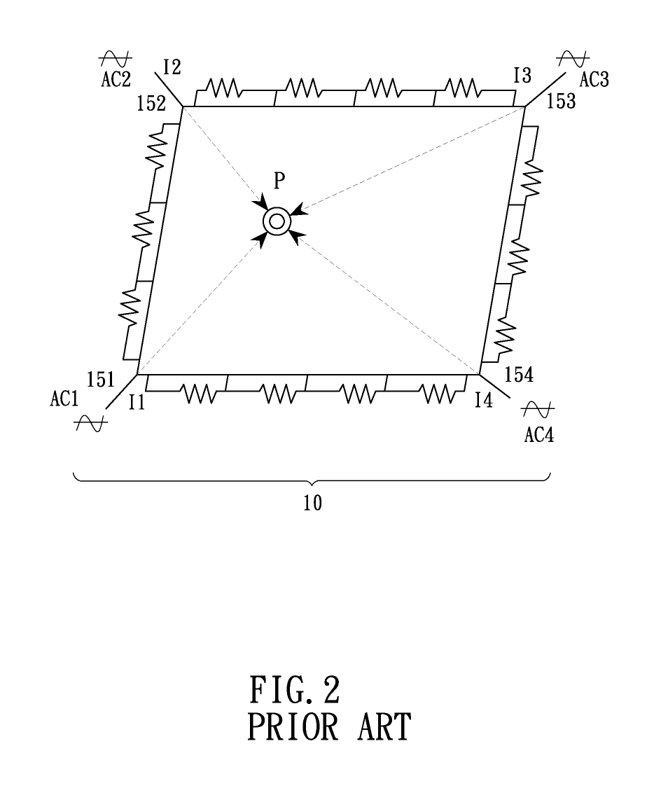

FIG. 3 is a schematically and pictorially decomposed illustration showing the rough architecture of a conventional projective capacitive touch panel.

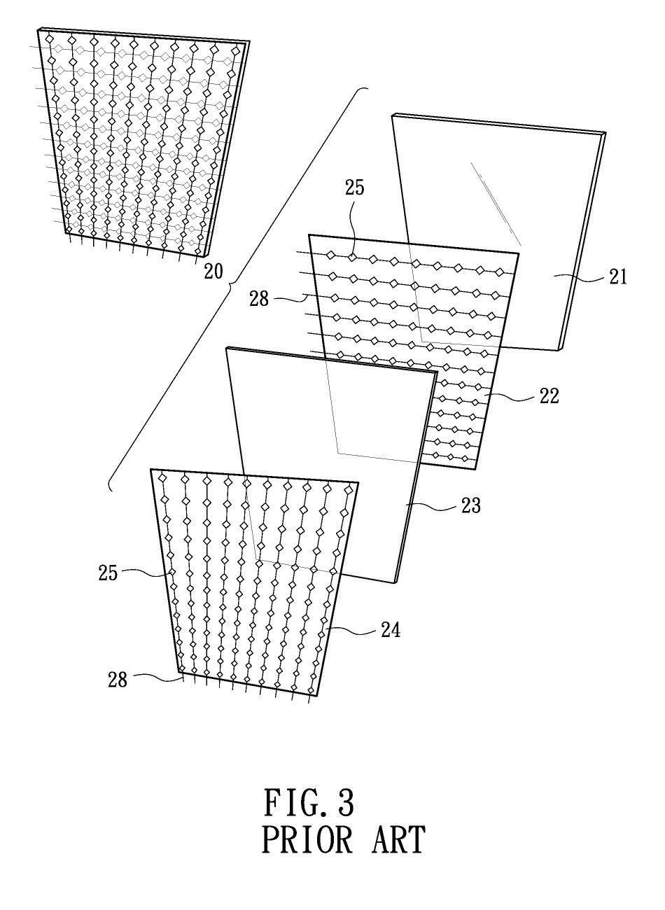

FIG. 4 is a schematically and pictorially decomposed illustration showing a surface capacitive touch panel of the invention.

FIG. 5 is a schematic plane view showing the surface capacitive touch panel of the invention.

FIGS. 6A to 6F are schematic plane views showing electrodes of the electrode pattern layer of the invention according to different implementations.

FIG. 7 is a schematic illustration showing that the surface capacitive touch panel of the invention receives sensing signals to determine multiple touch positions.

FIG. 8 is a schematic illustration showing the positions of the calibration touch points when the surface capacitive touch panel of the invention receives sensing signals to produce a calibration table.

FIG. 9 is a schematic plane view showing a surface capacitive touch panel according to another embodiment of the invention.

FIG. 10 is a schematic plane view showing a surface capacitive touch panel according to still another embodiment of the invention.

### DETAILED DESCRIPTION OF THE INVENTION

The present invention will be apparent from the following detailed description, which proceeds with reference to the accompanying drawings, wherein the same references relate to the same elements.

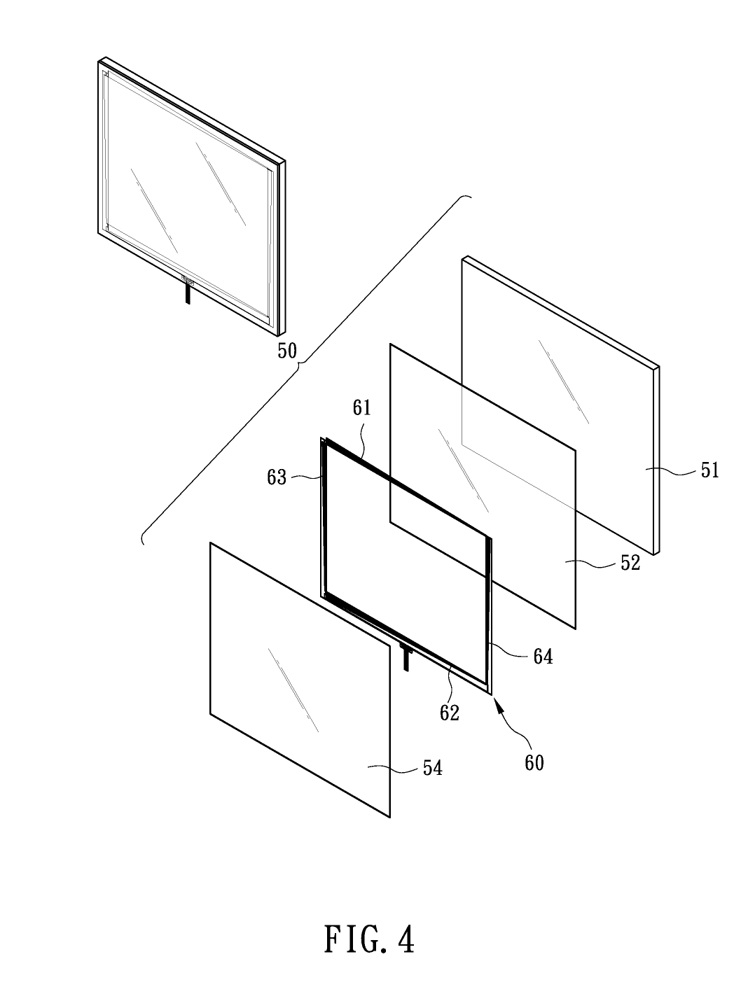

The invention provides a surface capacitive touch panel 50, as shown in FIG. 4. The touch panel 50 includes a transparent substrate 51, a transparent electroconductive layer 52, an electrode pattern layer 60 and a hard layer 54 for insulation protection. The electrode pattern layer 60 surrounds a substantially rectangular area on the surface periphery of the transparent electroconductive layer 52 of the touch panel 50, and the impedances of the opposite parallel edges of the electrode pattern layer 60 are configured in an ascending manner or a descending manner with a common difference or a common ratio toward the same side. Thus, impedances of two touch points on the same horizontal or vertical line of the touch panel 50 have a gradient phenomenon to prevent currents, outputted from the electrode pattern layer 60, from offsetting each other when the two touch points are moved. A controller (not shown) is utilized to measure the current intensities at four corners so that the X and Y coordinates of two different touch points may be calculated according to the current intensities.

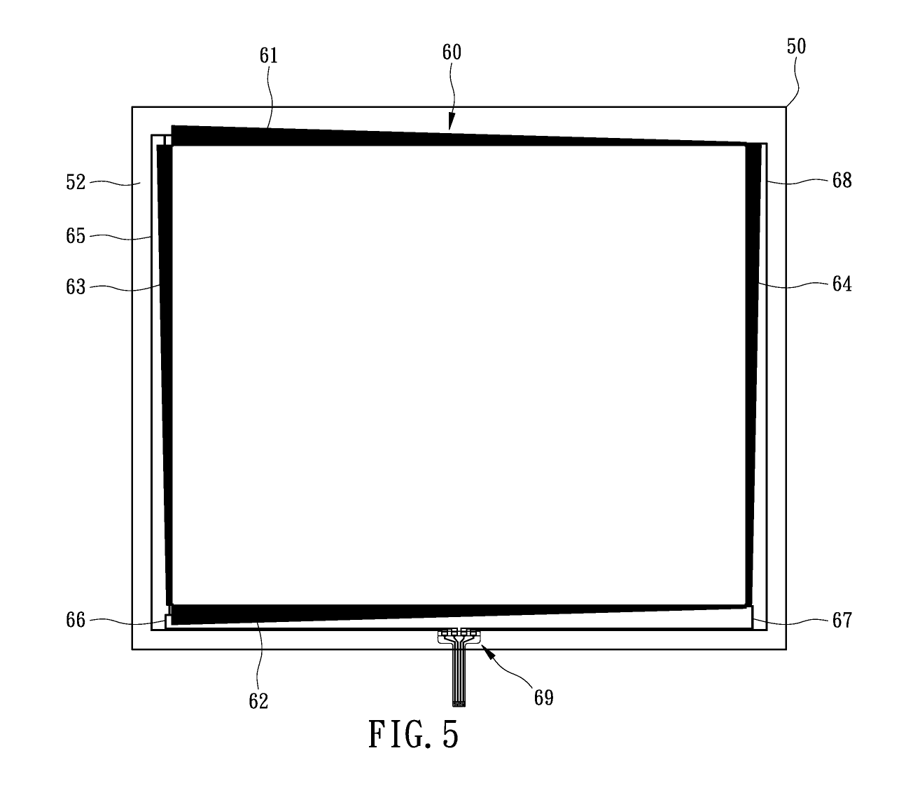

FIGS. 4 and 5 shows the detailed structure of the preferred embodiment of the invention. The transparent substrate 51 may be a transparent glass substrate or a transparent plastic substrate, while the transparent electroconductive layer 52 may be a transparent indium tin oxide film or an antimony tin oxide film. The hard layer 54 may be a silicon dioxide film for protecting the touch panel 50. Also, the electrode pattern layer 60 includes the opposite parallel first and second X-side electrodes 61, 62 and the opposite parallel first and second Y-side electrodes 63, 64, which surround a rectangular area and are formed on the surface periphery of the transparent electroconductive layer 52 of the touch panel 50. In addition, the inner edge of the electrode pattern layer 60 surrounds a substantially rectangular working area on the touch panel 50. The impedances of the first and second X-side electrodes 61, 62 and the first and second Y-side electrodes 63, 64 of the electrode pattern layer 60 are configured in an ascending manner or a descending manner with a common difference or a common ratio toward the same side.

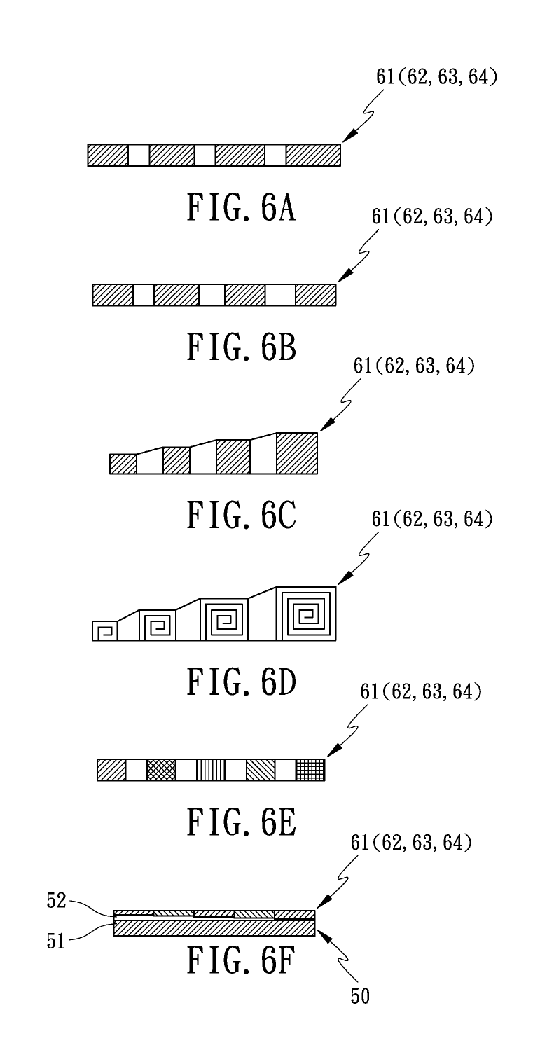

The best embodiment of the electrode pattern layer 60 of the invention will be described in the following. A first X-side electrode 61 and a second X-side electrode 62 are respectively disposed on top and bottom edges of the touch panel 50. The impedances of the first and second X-side electrodes 61, 62 descend or ascend with a common difference or a common ratio, wherein the physical condition may be changed by changing the slope (see FIG. 5), the width (see FIG. 6A), the gap (see FIG. 6B), the area (see FIG. 6C), the number of turns (see FIG. 6D), the material (see FIG. 6E), the thickness (see FIG. 6F) or a combination thereof. The best embodiment of the invention is to make the slopes of the first and second X-side electrodes 61, 62 gradually descend with the common difference toward the same right side so that its impedance descends with the common difference. Also, the electrode pattern layer 60 also includes a first Y-side electrode 63 and a second Y-side electrode 64 on the left and right edges of the touch panel 50. The impedances of the first and second Y-side electrodes 63, 64 descend or ascend with a common difference or a common ratio, wherein the physical condition may be changed by changing the slope (see FIG. 5), the width (see FIG. 6A), the gap (see FIG. 6B), the area (see FIG. 6C), the number of turns (see FIG. 6D), the material (see FIG. 6E), the thickness (see FIG. 6F) or a combination thereof. The best embodiment of the invention is to make the slopes of the first and second Y-side electrodes 63, 64 gradually descend with the common difference toward the same down side so that its impedance descends with the common difference.

In addition, the first and second X-side electrodes 61, 62 and the first and second Y-side electrodes 63, 64 of the electrode pattern layer 60 are formed on the periphery of the transparent electroconductive layer 52 of the touch panel 50 by way of etching, screen printing, electro-transfer printing, or the like. Furthermore, each of the first and second X-side electrodes 61, 62 and the first and second Y-side electrodes 63, 64 of the electrode pattern layer 60 is made of an electroconductive material, such as a carbon paste, a silver paste, a copper paste or a mixture thereof. In this embodiment, the carbon paste is utilized so that the electrode pattern layer 60 of the invention is formed on the surface periphery of the touch panel 50 by way of screen printing.

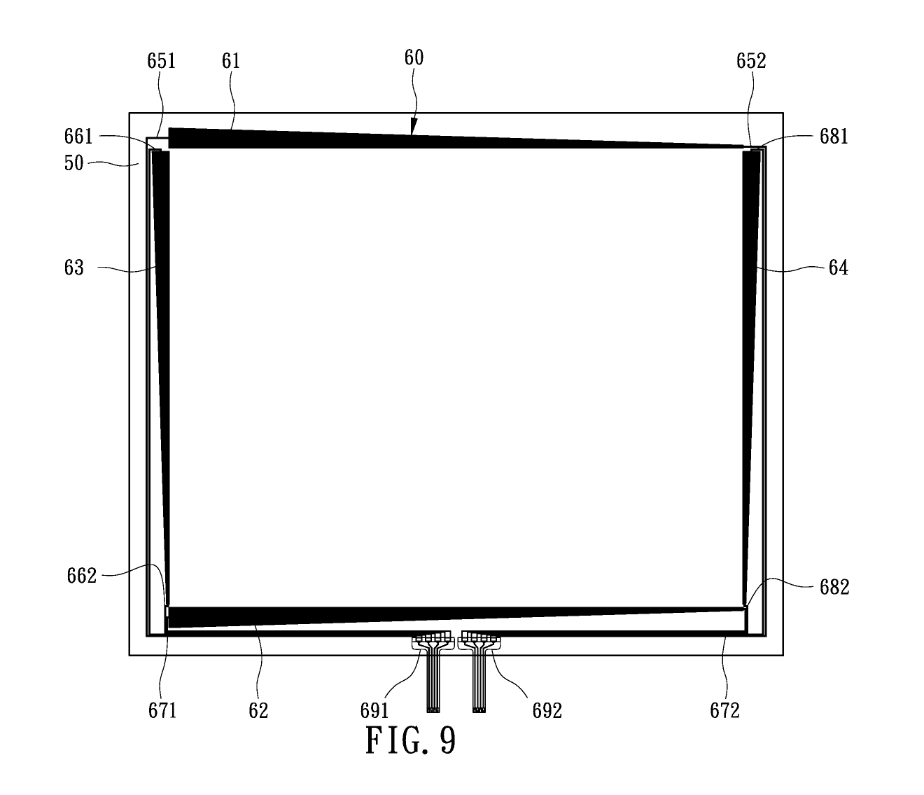

Furthermore, the electrode pattern layer 60 may include four output terminals (see FIG. 5) or eight output terminals (see FIG. 9). In the main embodiment of the invention, four output terminals are provided. The corresponding terminals of the first X-side electrode 61 and the first Y-side electrode 63 of the electrode pattern layer 60 are commonly provided with a wire 65 for measuring the voltage and the current. The corresponding terminals of the first Y-side electrode 63 and the first X-side electrode 62 are commonly provided with a wire 66 for measuring the voltage and the current. The corresponding terminals of the second X-side electrode 62 and the second Y-side electrode 64 are commonly provided with a wire 67 for measuring the voltage and the current. The corresponding terminals of the second Y-side electrode 64 and the first Y-side electrode 63 are commonly provided with a wire 68 for measuring the voltage and the current. Each of the wires 65 to 68 is made of the electroconductive material, such as the carbon paste, the silver paste, the copper paste or the mixtures thereof. In this invention, the silver paste is adopted, and the wires 65 to 68 are disposed on the surface of the non-work area of the touch panel 50 by way of screen printing. Also, the touch panel 50 also has a connection portion 69 for the layout of the other-side terminals of the wires 65 to 68 so that the wires 65 to 68 can be respectively electrically connected to a controller (not shown) of the touch panel 50.

Thus, the impedances of the first and second X-side electrodes 61, 62 and the first and second Y-side electrodes 63, 64 of the electrode pattern layer 60 are configured in an ascending manner or a descending manner with a common difference or a common ratio toward the same side, so that impedances of two touch points on the same horizontal or vertical line of the touch panel 50 have a gradient phenomenon to prevent currents, outputted from the electrode pattern layer 60, from offsetting each other when the two touch points are moved. Thus, a surface capacitive touch panel may be obtained.

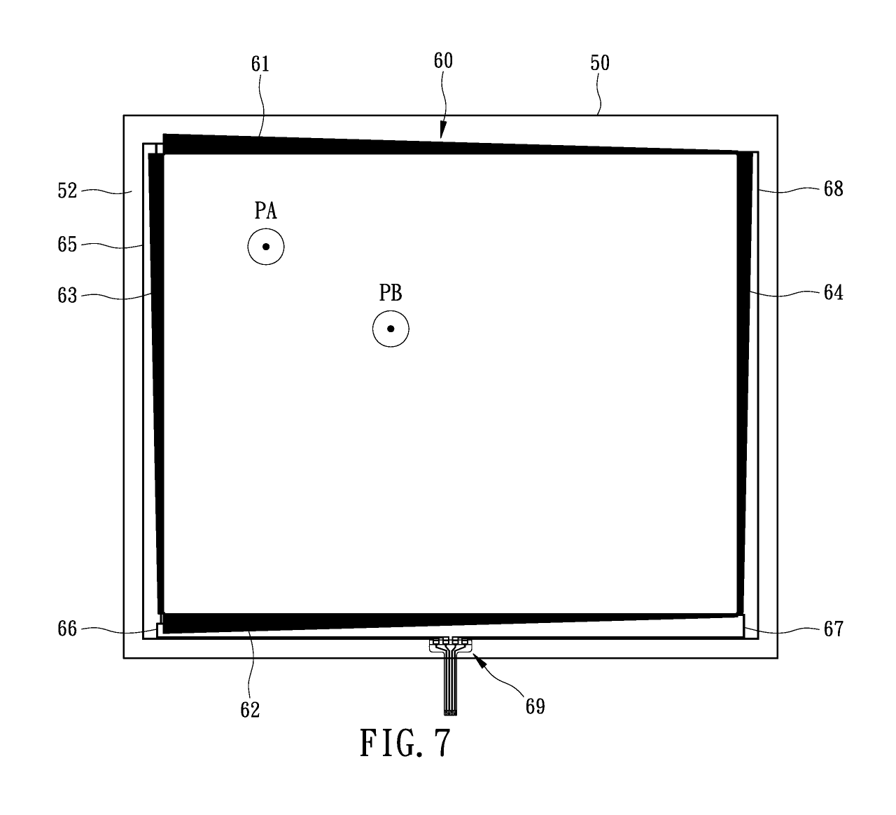

Regarding the actual application of the invention, as shown in FIG. 7, the external wires 65, 66, 67, 68 are connected to the corresponding four corners of the first and second X-side electrodes 61, 62 and the first and second Y-side electrodes 63, 64 of the electrode pattern layer 60 of the touch panel 50 to receive the AC sensing signals AC1, AC2, AC3, AC4 for the measurement of the positions of the two different touch points PA and PB on the touch panel 50. The following example for calculating the positions of the two different touch points PA, PB of the gesture operation will be described.

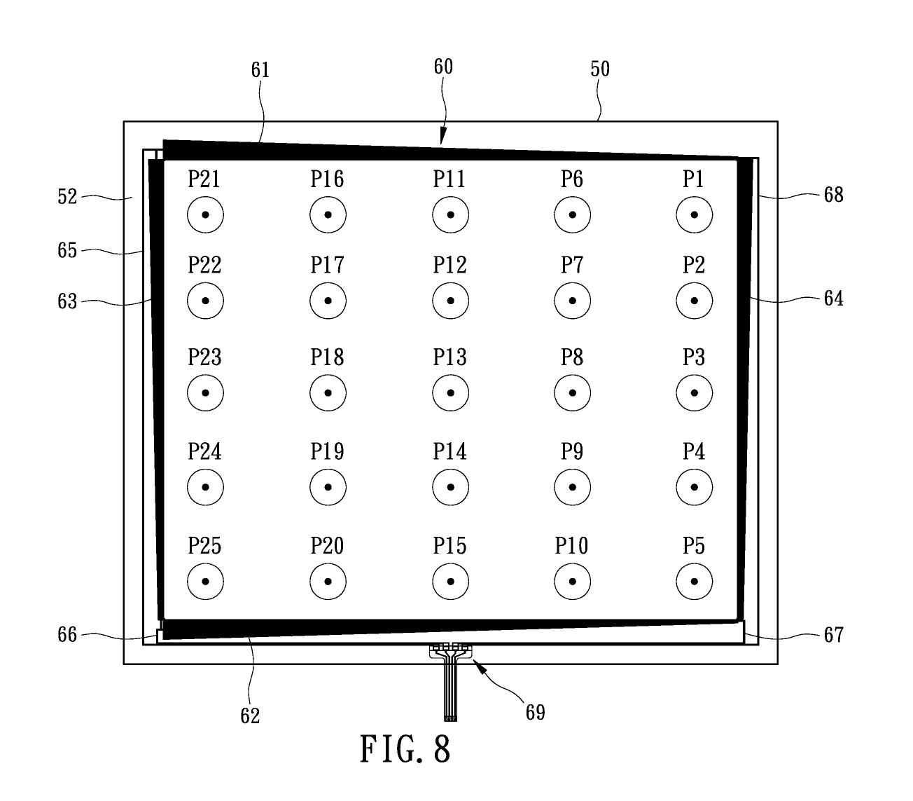

First, equally spaced calibration points are set on the working area of the touch panel 50, and the neighboring calibration points have the same X-axis pitch and the same Y-axis pitch, as shown in FIG. 8. In this main embodiment of the invention, 25 points are adopted, and the calibration points are respectively defined as P1 to P25.

Next, sensing members with the same area (the size thereof is equal to the simulated area touched by the finger) are sequentially disposed on the calibration points P1 to P25, and respectively measure the currents of the calibration points P1 to P25. The center points between the two neighboring calibration points P1 to P25 are obtained. In addition, the total energy (i.e., the current sum) and the individual energy (i.e., the individual current sum) of each of the first and second X-side electrodes 61, 62 and the first and second Y-side electrodes 63, 64 of the electrode pattern layer 60 are calculated by measuring the currents at the calibration points P1 to P25, so that the calibration table corresponding to each of the calibration points P1 to P25 is produced. The table includes the center points between the neighboring calibration points P1 to P25, the current sum, and the individual currents of the electrodes.

Thereafter, the calculation equation for the distance (i.e., the opening) and the relative angle between the two different touch points PA and PB may be obtained through the known center points between the calibration points P1 to P25, the current sum, and the individual currents of the electrodes.

Next, the current centers between the two touch points PA and PB are obtained according to the obtained distance and the relative angle between the two different touch points PA and PB in conjunction with the calibration table.

Finally, the X and Y coordinates of the two different touch points PA, PB are respectively obtained according to the distance, the angle and the current center between the two different touch points PA, PB.

In the operation architecture, the system generates a nonuniform electric field on the transparent electroconductive layer 52 of the touch panel 50. When the finger touches the touch panel 50, the capacitor charging effect appears, so that the capacitor coupling is formed between the finger and each of the first and second X-side electrodes 61, 62 and the first and second Y-side electrodes 63, 64 of the electrode pattern layer 60 on the touch panel 50, and the capacitor change is generated. The controller measures the current intensities at the four corners according to the above-mentioned method. In addition, the impedances of the first and second X-side electrodes 61, 62 and the first and second Y-side electrodes 63, 64 of the electrode pattern layer 60 are configured in the ascending manner or the descending manner with the common difference or the common ratio toward the same side. Thus, the impedances of two touch points on the same horizontal or vertical line of the touch panel 50 have a gradient phenomenon to prevent currents, outputted from the electrode pattern layer 60, from offsetting each other when the two touch points PA, PB are moved. Thus, the positions of the two different touch points PA, PB can be calculated according to the currents so that the controller can determine the subsequent scaling, rotating or dragging operation to satisfy the requirement of the multiple touch points of the surface capacitive touch panel. In addition, the constitution and the manufacturing difficulty of the multi-point touch panel can be significantly simplified, and the manufacturing cost can be reduced.

FIG. 9 is a schematic plane view showing a surface capacitive touch panel according to another embodiment of the invention, wherein the electrode pattern layer 60 has eight output terminals. As shown in FIG. 9, two ends of the first X-side electrode 61 of the electrode pattern layer 60 are respectively provided with wires 651 and 652 for measuring voltages and currents, and two ends of the first Y-side electrode 63 are respectively provided with wires 661 and 662 for measuring voltages and currents. Also, two ends of the second X-side electrode 62 are respectively provided with wires 671 and 672 for measuring voltages and currents, and two ends of the second Y-side electrode 64 are respectively provided with wires 681 and 682 for measuring voltages and currents. The wires 651, 652, 661, 662, 671, 672, 681 and 682 may be made of an electroconductive silver paste, and are disposed on the surface of the non-work area of the touch panel 50 by way of screen printing. Also, the touch panel 50 also has connection portions 691 and 692 for the layout of the other-side terminals of the wires 651, 652, 661, 662, 671, 672, 681 and 682 so that the wires 651, 652, 661, 662, 671, 672, 681 and 682 can be respectively electrically connected to the controller (not shown) of the touch panel 50.

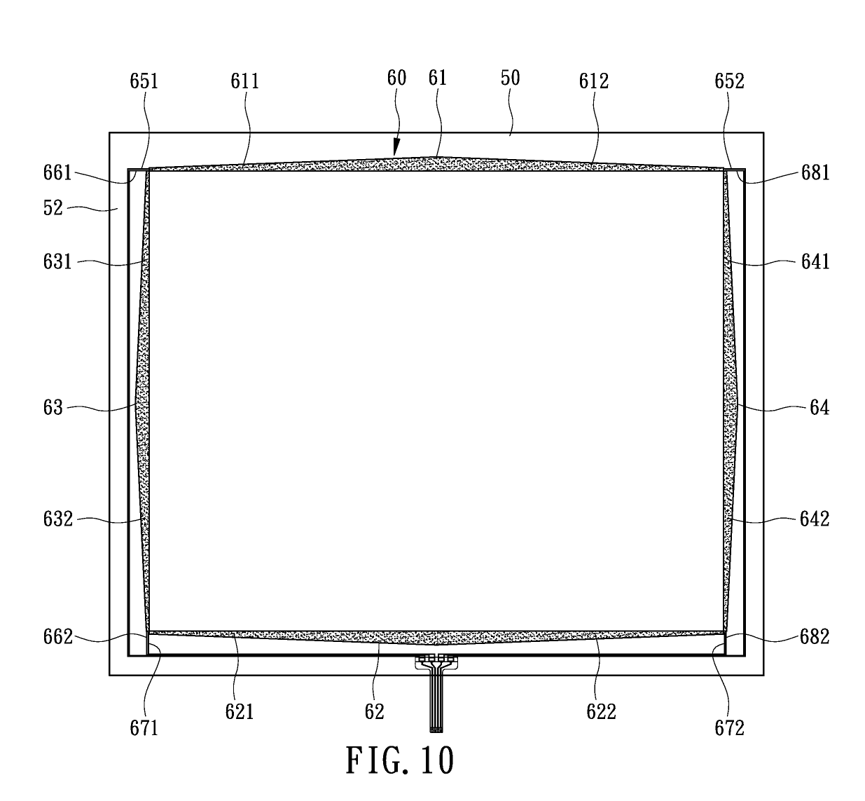

FIG. 10 shows still another embodiment of the invention. As shown in FIG. 10, each of the first and second X-side electrodes 61, 62 and the first and second Y-side electrodes 63, 64 of the electrode pattern layer 60 has multiple segments, so that the electrode pattern layer 60 surrounds a plurality of corresponding virtual working areas on the touch panel 50. The impedances of each segment of the first and second X-side electrodes 61, 62 and each segment of the first and second Y-side electrodes 63, 64 are configured in an ascending manner or a descending manner with a common difference or a common ratio toward the same side. In the preferred state of this embodiment, the first and second X-side electrodes 61, 62 have two first X-side electrode segments 611 and 612 connected in series, and two second X-side electrode segments 621 and 622 connected in series. The slopes of the two first X-side electrode segments 611, 612 and the two second X-side electrode segments 621, 622 gradually descend with a common difference from the middle connection points therebetween to two ends. Thus, the impedances of the first and second X-side electrodes 61, 62 descend from the middle to the two ends, so that the impedances descend with the common difference. The first and second Y-side electrodes 63, 64 have two first Y-side electrode segments 631, 632 connected in series, and two second Y-side electrode segments 641, 642 connected in series. The slopes of the two first Y-side electrode segments 631, 632 and the two second Y-side electrode segments 641, 642 gradually descend with a common difference from the middle connection points therebetween to top and bottom ends. Thus, the impedances of the first and second Y-side electrodes 63, 64 descend from the middle to the two ends, so that the impedances descend with the common difference. Consequently, impedances of two touch points on the same horizontal or vertical line of the touch panel 50 have a gradient phenomenon to prevent currents from offsetting each other when the two touch points are moved. The positions of different touch points are calculated according to the currents, so that the surface capacitive touch panel can satisfy the requirement of the multi-point touch function, and the manufacturing cost can be reduced.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. A surface capacitive touch panel with a multi-point touch structure, the touch panel comprising:
a transparent substrate, a transparent electroconductive layer and an electrode pattern layer stacked together, wherein:
the electrode pattern layer comprises opposite at least one first X-side electrode and at least one second X-side electrode on top and bottom edges of the touch panel, and opposite at least one first Y-side electrode and at least one second Y-side electrode on left and right edges of the touch panel, and the first and second X-side electrodes and the first and second Y-side electrodes surround a rectangular area and are disposed on a surface periphery of the touch panel;
impedances of the first and second X-side electrodes ascend or descend with a common difference or a common ratio toward the same side, impedances of the first and second Y-side electrodes ascend or descend with a common difference or a common ratio toward the same side, and end portions of the first and second X-side electrodes and the first and second Y-side electrodes are respectively electrically connected to wires for measuring output currents;
impedances of two touch points on the same horizontal or vertical line of the touch panel have a gradient phenomenon to prevent currents from offsetting each other when the two touch points are moved; and
positions of the two different touch points are calculated according to the currents, so that the surface capacitive touch panel can determine multiple touch points.

2. The touch panel according to claim 1, wherein the impedances of the electrode pattern layer ascend or descend with the common difference or the common ratio toward the same side by changing a slope, a width, an area, a thickness, a gap, a material, the number of turns or a combination thereof.

3. The touch panel according to claim 1, wherein the electrode pattern layer is formed on the transparent electroconductive layer by way of screen printing.

4. The touch panel according to claim 1, wherein the electrode pattern layer is made of an electroconductive carbon paste.

5. The touch panel according to claim 1, wherein the first and second X-side electrodes of the electrode pattern layer are respectively composed of more than two opposite parallel first and second X-side electrode segments connected in series.

6. The touch panel according to claim 1, wherein the first and second Y-side electrodes of the electrode pattern layer are respectively composed of more than two opposite parallel first and second Y-side electrode segments connected in series.

7. A multi-point touch method for a surface capacitive touch panel, the touch panel comprising a transparent substrate, a transparent electroconductive layer and an electrode pattern layer stacked together, wherein the electrode pattern layer has opposite parallel one or more first and second X-side electrodes and opposite parallel one or more first and second Y-side electrodes, which surround a rectangular area and are disposed on a surface periphery of the transparent electroconductive layer, the method comprising:
making impedances of two touch points on the same horizontal or vertical line of the touch panel have a gradient phenomenon to prevent currents from offsetting each other when the two touch points are moved.

8. The method according to claim 7, wherein impedances of the first and second X-side electrodes are configured to ascend or descend with a common difference or a common ratio toward the same side, and impedances of the first and second Y-side electrodes are configured to ascend or descend with a common difference or a common ratio toward the same side.

9. The method according to claim 8, wherein the impedances of the first and second X-side electrodes and the first and second Y-side electrodes ascend or descend with the common difference or the common ratio toward the same side by changing a slope, a width, an area, a thickness, a gap, a material, the number of turns or a combination thereof.
